(19) United States
(12) Patent Application Publication
(10) Pub. No.: US 2026/0133633 A1
(43) Pub. Date: May 14, 2026

(54) ADJUSTABLE AND REUSABLE WEARABLE ACCESSORY TO ENHANCE A SIMULATED ENVIRONMENT

(71) Applicant: Case Western Reserve University, Cleveland, OH (US)

(72) Inventors: Emily GRACZYK, North Royalton, OH (US); Luis Mesias FLORES, Cleveland, OH (US); Eric CHEN, Highland Park, NJ (US); Shifra M. NARASIMHAN, Athens, OH (US); Susan SCHRAMFIELD, Cleveland, OH (US)

(21) Appl. No.: 19/489,375

(22) PCT Filed: May 31, 2024
(86) PCT No.: PCT/US2024/031815

§ 371 Date: Dec. 2, 2025

Related U.S. Application Data
(60) Provisional application No. 63/505,436, filed on Jun. 1, 2023.
(60) Provisional application No. 63/551,224, filed on Feb. 8, 2024.

(51) Int. Cl. G06F 3/01

(52) U.S. Cl. CPC G06F 3/014; G06F 3/016

(57) ABSTRACT

A re-usable wearable device includes a flexible PCB having a re-sizable hand portion with an attachment mechanism and at least one re-sizable digit portion. Each of the re-sizable digit portions includes at least one electrode connected to the flexible PCB by an adjustable electrode holder. Each electrode is positioned in close contact with the skin to provide electrical stimulation causing a referred sensation in another portion of the hand. Each electrode holder includes a setting with a track and anchoring mechanism for positioning the electrode at a radial position on the digit. The device can include sensors to measure the position and movements of the hand to augment or replace optical hand tracking information. The wearable device can provide referred sensation via electrical stimulation and improved position information.

### RELATED APPLICATIONS

This application claims priority to U.S. Provisional Application Ser. No. 63/551,224, filed 8 Feb. 2024, entitled “ADJUSTABLE AND REUSABLE WEARABLE ACCESSORY TO ENHANCE A SIMULATED ENVIRONMENT,” and also claims priority to U.S. Provisional Application Ser. No. 63/505,436, filed 1 Jun. 2023, entitled “EXO-TRACE HAPTIC STIMULATION AND POSITION SENSING INTERFACE.” The entireties of these applications are hereby incorporated by reference for all purposes.

### TECHNICAL FIELD

This disclosure relates generally to a re-usable wearable accessory for use in connection with a simulated environment, and more specifically to an adjustable, re-usable wearable accessory that is low profile and light weight and can enhance experience and interactions in a simulated environment by providing referred sensation of an action to a user via electrical stimulation and improved position information.

### BACKGROUND

As the gaming industry has evolved to include more advanced technologies, users have been introduced to situations in which actions are performed in a simulated environment (e.g., a remote simulated environment, an extended reality (XR) environment, a virtual reality (AR) environment, an augmented reality (AR) environment, a mixed reality (MR) environment, a remote veridical (e.g., teleoperation) environment, or the like). Haptic feedback and position tracking capabilities can make the gaming experience (or other virtual experience) more realistic to a user. Current haptic feedback technologies include vibrational motors, force feedback exoskeletons, pneumatic bladder systems, and generic electrical stimulation. These current haptic feedback technologies tend to be bulky, stationary, impede user movement, have limited workspaces, or the like. Moreover, these current haptic feedback technologies are unable to provide a natural representation of touches related to actions occurring in the simulated environment. Currently, electrical nerve stimulation has been modified to cause sensations that represent touches related to actions in the simulated environment when applied at the position meant to feel a touch. However, this modified electrical stimulation significantly impedes user movement as it still requires a delivery mechanism that must be positioned at the location meant to feel the sensation. Accordingly, devices that can apply the modified electrical nerve stimulation are bulky, not re-sizable, and have limited abilities to provide sensations (e.g., sensation can only be felt at the position of an electrode).

### SUMMARY

Described herein is a wearable accessory that can be used in connection with a simulated environment (e.g., a remote simulated environment, an extended reality (XR) environment, a virtual reality (VR) environment, an augmented reality (AR) environment, a mixed reality (MR) environment, a remote veridical (e.g., teleoperation) environment, or the like) to provide referred sensation to a user via electrical stimulation and position information about at least a portion of the user by tracking joint angles and portions of the device in an optical tracking system. Notably, the wearable accessory can be low-profile, lightweight, adjustable, and reusable.

In an aspect, the present disclosure can include a system that includes a re-usable wearable device that includes a flexible PCB and a signal generator connected to the wearable device. The re-usable wearable device includes the flexible PCB that further includes a re-sizable hand portion and at least one re-sizable digit portion. The re-sizable hand portion is configured to be worn on at least a portion of a hand of a user and includes an attachment mechanism to anchor the re-sizable hand portion to the hand of the user. Each of the at least one re-sizable digit portion are configured to be worn on at least a portion of a digit of the hand and include at least one electrode, an electrode holder for each of the at least one electrode. The at least one electrode is connected to the flexible PCB and configured to be positioned in close contact with an area of the user's skin to provide electrical stimulation causing a referred sensation in another portion of the hand. Each of the electrode holders is connected to the flexible PCB and configured to hold one of the at least one electrode close to the skin with an adjustable electrode setting. Each electrode holder is configured to enable adjustment of the at least one electrode to positions on a proximal-distal axis of the digit. The adjustable electrode setting includes a track and anchoring mechanism for positioning the electrode at a radial position on the digit. The signal generator is connected to the wearable device and configured to send an electrical signal to the at least one electrode configured to be used for the electrical stimulation causing the referred sensation.

In another aspect, the present disclosure can include a method for creating a referred sensation in a user of the wearable device that includes the following steps. Receiving, by a controller of a re-usable wearable device, data related to a sensation to be felt by a user of the wearable device from an external device, wherein the wearable device is re-usable and comprises a flexible PCB. The wearable device further includes a re-sizable hand portion configured to be worn on at least a portion of a hand of a user and including an attachment mechanism to anchor the re-sizable hand portion to the hand of the user, and at least one re-sizable digit portion, each digit portion configured to be worn on at least a portion of a digit of the hand. Each of the at least one re-sizable digit portions includes at least one electrode and an electrode holder for each of the at least one electrode. The at least one electrode is connected to the flexible PCB and configured to be positioned in close contact with an area of the user's skin to provide electrical stimulation causing a referred sensation in another portion of the hand. Each of the electrode holders is connected to the flexible PCB and configured to hold one of the at least one electrode close to the skin with an adjustable electrode setting. Each electrode holder is configured to enable adjustment of the at least one electrode to positions on a proximal-distal axis of the digit. The adjustable electrode setting includes a track and anchoring mechanism for positioning the electrode at a radial position on the digit. Selecting, by the controller, one or more electrodes of the at least one electrode to deliver the electrical stimulation to the user at a location of each of the selected one or more electrodes. Determining, by the controller, at least one parameter for the electrical stimulation to be delivered to each of the selected one or more electrodes based on the data related to the sensation. And, sending, by the controller, the electrical stimulation with the at least one parameter to each of the selected one or more electrodes to apply the electrical stimulation to cause the user to feel the referred sensation in the other portion of the hand.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIGS. 1 and 2 are diagrams showing example systems that can be used to deliver surface electrical nerve stimulation causing user's body to experience a natural sensation of an action/event occurring in a simulated environment in accordance with an aspect of the present disclosure;

FIG. 3 is a diagram showing an example of a user wearing an example system similar to that of FIGS. 1 and/or 2;

FIG. 4 is a diagram showing an example of at least a portion of the wearable device of FIGS. 1 and/or 2 configured to fit around a finger and a hand;

FIG. 5 is a diagram showing an example of the functionality of the wearable device of FIGS. 1 and/or 2;

FIGS. 6-10 are photographs showing a user wearing an example of the wearable device of FIGS. 1 and/or 2 from various viewpoints;

FIGS. 11-18 are photographs of all or parts of the wearable device of FIGS. 1 and/or 2 not being worn by a user from various viewpoints;

FIG. 19 is a photograph of the user wearing the example of the low contrast wearable device of FIGS. 1 and/or 2;

FIG. 20 is process flow diagram illustrating a method for delivering surface electrical nerve stimulation to a nerve for a user to experience a natural sensation in accordance with another aspect of the present disclosure;

FIG. 21 is a process flow diagram illustrating a method for positioning a wearable device on a user's hand in accordance with a further aspect of the present disclosure; and

FIG. 22 is a process flow diagram illustrating a method for determining whether a wearable device is properly calibrated for the user, in accordance with another aspect of the present disclosure.

### DETAILED DESCRIPTION

### I. Definitions

Unless otherwise defined, all technical terms used herein have the same meaning as commonly understood by one of ordinary skill in the art to which the present disclosure pertains.

As used herein, the singular forms “a,” “an,” and “the” can also include the plural forms, unless the context clearly indicates otherwise.

As used herein, the terms “comprises” and/or “comprising,” can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

As used herein, the terms “first,” “second,” etc. should not limit the elements being described by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the term “wearable accessory” can refer to an article that can be worn on at least one part of a body of the user (e.g., a finger, a hand, an arm, a foot, or the like.). As an example, a wearable accessory can be a wearable hand accessory with at least one portion that can be worn on a portion of a digit (e.g., finger and/or thumb) and at least one portion that can be worn on at least a portion of the hand itself (e.g., the palmar portion of the hand). The wearable hand accessory can be, for example, one or more of a fingertip-less glove, a finger-less glove, a partial glove, a full glove, an elbow length (evening) glove, a sock, or the like. The term “wearable device” can be used interchangeably with “wearable accessory”.

As used herein, the term “adjustable” can refer to a wearable accessory that can be modified to fit a body part of a user (e.g., an adult user) of any size (or at least any sizes within a given deviation from a median size). An adjustable wearable accessory can include one or more mechanisms for tightening/loosening or shortening/lengthening portions of the adjustable wearable device. In some instances, an adjustable wearable accessory can be generally sized based on a median population size of a male, female, and/or child/adult and adjustable (e.g., for a percentage around the median population size). An article that is adjustable can include one or more adjustment mechanisms (e.g., tighteners, Velcro, elastic, etc.).

As used herein, the term “reusable” can refer to a property or ability of an article (e.g., a wearable accessory) to be used more than once, by the same user and/or a different user, while remaining operable and/or without becoming inoperable for its given use. A reusable article can be re-used and re-sized multiple times by one or more users.

As used herein, the term “digital nerve(s)” can refer to one or more branches of a sensory nerve generally running from the wrist or ankle to the tip of a digit (e.g., finger, toe, etc.). Generally, digital nerves are superficial (e.g., near the skin) and reduce in diameter from wrist or ankle to the fingertip or toe tip. With respect to digits of the hand, each digit can have two digital nerve trunks with a plurality of branches, one running along each side of the digit. The digital nerves of the hand can be dorsal or palmar and can be descended from at least one of the median, ulnar or radial nerve (wrist and part of palm can include musculocutaneous and medial antebrachial cutaneous nerve).

As used herein, the term “flexible” can refer to an ability of a material to deform elastically (e.g., bend, compress, stretch, etc.) when a stress is applied to the material and subsequently return to its original shape when the applied stress is removed. Materials including spandex and elastic are non-limiting examples of flexible materials.

As used herein, the term “flexible printed circuit board (PCB)” can refer to any type of flexible platform or substrate that can include and/or hold at least one flexible conductor capable of transmission of an electrical signal. For example, a flexible substrate can include plastic or cloth with wires embedded or otherwise attached to it.

As used herein, the term “haptic feedback” can refer to the use of any type of somatosensation (e.g., touch, force, pain, proprioceptive sensation, or the like) to communicate with a user of a wearable accessory. When used in connection with a simulated environment (e.g., a remote simulated environment, an extended reality (XR) environment, a virtual reality (VR) environment, an augmented reality (AR) environment, a mixed reality (MR) environment, a remote veridical (e.g., teleoperation) environment, or the like), the haptic feedback can be delivered in response to an action occurring and/or that has occurred in the simulated environment. As used herein, haptic feedback can be delivered to a user as a referred sensation by applying an electrical nerve stimulation via a wearable accessory. The electrical stimulation is delivered to a first location on a nerve more proximal than at least a second location where the sensation is felt. The referred sensation mimics and/or represents (e.g., if the natural sensation would be unsafe, painful, or the like) a natural sensation for the user at the at least the second location, rather than the location that was stimulated.

As used herein, the term “natural sensation” can refer to an elicited perception/sensation that mimics and/or replicates the actual physical feeling of an action occurring in a simulated and/or remote environment as if the action was occurring to the user in real life. Natural sensation can be different from a sensation due to a mechanical and/or direct stimulus (e.g., vibrations, point forces, direct electrical shock, etc.). In other words, natural sensation can be thought of as a perception that the user is actually touching something or feeling a touch sensation at a location with nothing actually touching that location. In contrast, mechanical and/or direct stimuli cause sensations that do not provide a natural perception and instead replace a natural perception with an alternative feeling (e.g., vibration, pain, paresthesia, etc.). In some instances, the perception of natural sensation can be elicited via an electrical nerve stimulation of one or more sensory nerves.

As used herein, the term “referred sensation” relates to a somatosensory feeling that is perceived to emanate from a body part other than, but in association with, the body part being stimulated. For example, a distally referred sensation can be caused by stimulating a nerve at or near a first location (a more proximal location) to introduce a somatosensory feeling at a second, more distal, location (e.g., a fingertip) associated with the first location (e.g., connected on a same nerve, same nerve root, same vertebral level, or the like). The referred sensation can at least approximate a natural sensation at the second location. For example, a natural sensation can be felt at a fingertip as a referred sensation when an electrical signal is delivered at a remote (more proximal) location on a nerve, which can be the same sensory nerve.

As used herein, the term “electrical nerve stimulation” can refer to the delivery of an electrical signal (current and/or voltage), which can include one or more electrical pulses, to cause one or more nerves to conduct one or more action potentials. Electrical nerve stimulation and “electrical stimulation” may be used interchangeably herein. Examples of the electrical pulses can include square, rectangular, ramp, logarithmic, exponential, and the like. The electrical pulses can be a single pulse, but also may include patterns of two or more pulses. The electrical signal can be delivered by one or more skin surface electrodes in some examples.

As used herein, the term “joint angle” (also called inter-segmental angle) can refer to the angle formed between the two segments on either side of the joint (with the joint as the vertex), usually measured in degrees and often converted to clinical notation. Joint angles are relative to the segment angles and do not change with the body orientation. Joint angles can be tracked with an integrated encoder (e.g., a digital encoder and/or an analog encoder) and/or optical tracking and can be used for kinematic calculations and/or to increase accuracy/precision of a simulation. For instance, tracking joint angles can further improve capture of the simulated user movement in the simulated environment for a more seamless experience. In another instance, tracking joint angles can more accurately and/or precisely instruct movements or changes in a remote device teleoperated based on the user's movement.

As used herein, the term “simulated environment”, also referred to as a “simulated remote environment”, can refer to an at least partially computer-implemented environment that user can experience and/or interact with, including but not limited to locations, objects, simulated beings, and other users of the at least partially computer-generated environment. The term can refer to the environment being at least partially veridical but in a different location from the user so the user visualizes the environment through a simulation. For example, actions can occur in the simulated remote environment that may be controlled by the user or can happen to the user. The simulated remote environment may exist in extended reality (XR) and/or may be a veridical (real world) environment located remote from a user.

As used herein, the term “intensity” of an action occurring in a simulated remote environment can refer to a measurable amount of a property related to the action. For example, a force associated with an action. The intensity of the action can be reflected in an electrical stimulation signal by varying one or more parameters related to strength and/or one or more parameters related to timing.

As used herein, the term “skin surface electrode” can refer to an electrode that can be placed on or near the surface of a user's skin to transmit an electrical signal through the user's skin to a nerve. For example, one or more skin surface electrodes (e.g., that are part of a wearable accessory) can be positioned at one or more first areas of a user's body (e.g., in a predefined position using the wearable accessory worn by a user, such as a location over a portion of a digital nerve) to deliver at least a part of an electrical stimulation to the at least one first area of the user's body to induce at least one second area of the user's body (e.g., at a location on the same digital nerve distal from the first area) to experience a level of natural sensation. A skin surface electrode can be safe for contact with the skin (e.g., electrical stimulation with the skin surface electrode does not harm the user). As non-limiting examples, a skin surface electrode can include at least one of stainless steel, gold, silver/silver chloride, a conductive polymer, or the like.

As used herein, the term “low profile” can refer to an article that is lower in volume and/or height or slimmer than is usual for objects of the article's type. The article can be a wearable accessory, that fits close to the body part it is worn on (e.g., can be slimmer or less noticeable than the average similar article). For example, a low profile wearable accessory can be fitted close to the skin of the hand and digits, such that the shape of the hand and digits are not substantially obscured. As a non-limiting example, the low profile wearable accessory can include components with a size of 5 mm or thinner (e.g., measured from the skin outward). As another non-limiting example, the low profile wearable accessory can be configured to be “skin tight” (e.g., fit very tightly to the skin to show the shape of the body) over at least one of the joints of the hand of the user.

As used herein, the term “contrast” can refer to the difference in luminance and/or color between one or more articles, portions of article(s), or background objects that are recorded by an imaging system (e.g., an optical tracking system, an eye, etc.). Contrast may be defined by color contrast, luminance contrast, Weber contrast, Michelson contrast, RMS contrast, or the like. Contrast can be dependent on the capabilities and/or specifications of a given image recording device. For example, if an optical tracking system associated with the simulation environment that the wearable accessory is connected with “sees” in a given color scale (e.g., gray-scale, full color, partial color, or the like) then the definition of “low” contrast and “high” contrast can vary. The wearable accessory can be “low” contrast (including one or more colors that appear similar to skin in the optical tracking system's vision so as to not disrupt tracking of the hand).

As used herein, the term “lightweight” can refer to an article with a thin material or build that has a weight that is less than average and generally not noticeable, or not noticeable after an initial getting used to it period, when worn by an average user of the article. For example, the system can have a weight of one pound or less, half of a pound or less, a quarter of a pound or less, or the like.

As used herein, the term “user” can refer to one or more humans that is wearing the wearable accessory and may be at least partially immersed in a simulated environment.

### II. Overview

A user can utilize a wearable accessory to enhance an experience in a simulated environment (e.g., a remote environment, an extended reality (XR) environment, an augmented reality (AR) environment, a virtual reality (VR) environment, a mixed reality (MR) environment, a veridical environment located remote from a user, or the like). For example, the wearable accessory can make the simulated environment seem more realistic to the user when haptic feedback is delivered to the user as actions occur in the simulated environment and when movements of the user are better tracked. However, current haptic feedback and/or tracking technologies for use with simulated environments cannot provide a natural representation of touches related to actions occurring in the simulated environment and/or severely impede a user's real-life mobility. Electrical nerve stimulation may be used to provide a more natural representation, but currently available electrical nerve stimulation used to provide haptic feedback is not realistic and is often described as uncomfortable or is known to cause paresthesia/numbness. Generally, such electrical nerve stimulation is stimulating the location meant to feel the sensation (e.g., sensation on the fingertip can come from a stimulation by an electrode on the fingertip), which can get in the way of a user's movements and function, as well as tracking of movements of the hand. A re-usable, wearable accessory that can create referred sensations in a user and that is light weight, low profile, adjustable, and trackable is needed to advance use of simulated environments (for both work and pleasure).

The present disclosure describes a re-usable wearable accessory configured to connect with a signal generator that is capable of creating signals configured to generate referred sensations in a user of the wearable accessory. Referred sensation can be created by delivering an electrical stimulation to a location on at least one of the user's digital nerves that is more proximal than the location where the sensation is felt on that digital nerve. This approach targets the nerves connecting the brain to the region where sensory receptors exist (e.g., on the fingertip) and as the stimulation activates those nerves from location (e.g., along the finger), the brain associates the nerve activity with sensations that occur at the region(s) on the fingertip that those nerves are connected to even though the sensory receptors in those region(s) on the fingertip have not been activated by physical contact, force, or direct stimulation. It should be noted that this stimulation mechanism targets a nerve rather than a mechanoreceptor to provide sensation at a location different from the stimulation location. For example, if the user is playing a VR game and picks up an object (which should be felt at least by the user's fingertips), the signal generator can generate an electrical signal to send to at least one electrode of the wearable accessory (located a distance proximal to the fingertip but on the same digital nerve) that causes a referred sensation in the fingertip such that the user can feel the sensation related to the simulated action of picking up the object. The wearable accessory additionally improves tracking of the movements of the hand wearing the wearable accessory. Improved haptic feedback and tracking of hand movements greatly improves the realism and usability of simulated environments, such as XR gaming environments, and remote veridical environments, such as for teleoperation of medical or flying devices. The wearable accessory is importantly re-usable and adjustable to fit a number of different users and to calibrate electrode positionings more accurately along the hand and/or digits for the most realistic referred sensation while not impeding movements of the user.

### III. Systems

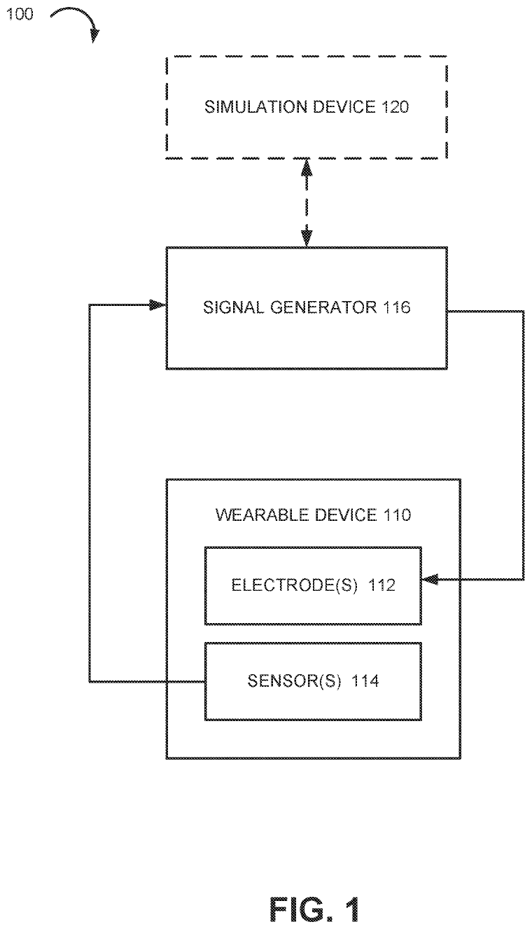

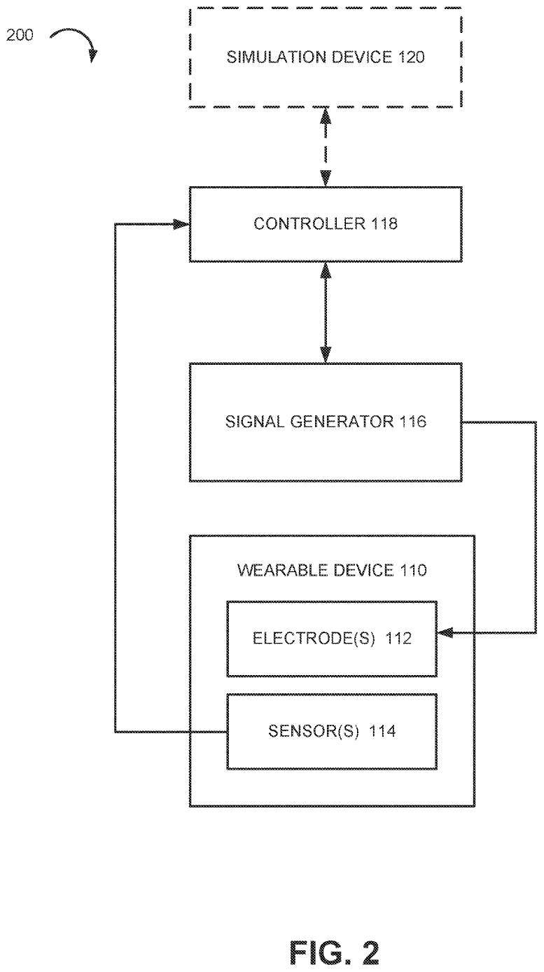

FIGS. 1 and 2 show example systems 100, 200 that can deliver a sensation to a user as haptic feedback using a wearable device 110 when an action/event occurs and/or has occurred in a simulated environment (e.g., a remote environment, an extended reality (XR) environment, an augmented reality (AR) environment, a virtual reality (VR) environment, a mixed reality (MR) environment, a veridical environment located remote from a user, or the like) which may be embodied/displayed on a simulation device 120. The wearable device 110 can be light weight, low profile, and adjustable to fit one or more different users. For example, the wearable device 110 can be configured and/or reconfigured for different users and/or different uses. The wearable device 110 can be re-usable. The wearable device 110 is described herein with respect to being worn on at least a hand (e.g., palm and at least one digit), but it should be understood that this description is not intended to be limiting and the wearable device may be configured for use on any body part (e.g., one or more digits, at least part of a hand, at least part of a wrist, at least part of an arm, at least part of a shoulder, at least part of a foot, at least part of an ankle, at least part of a leg, at least part of a hip, etc.). Even though the wearable device 110 can be re-sized, in some instances, the wearable device 110 can come in different general sizes (e.g., small, medium, and large) based on anthropometric groupings for a user to choose a wearable device more closely fitting the shape and/or size of the user's hand, foot, and/or limb. Wearable device 110 can also include a left and/or a right designation and, in some instances, two wearable devices can be used simultaneously (e.g., one on each of a user's hands or feet).

The systems 100, 200 both include the wearable device 110 and a signal generator 116. At least one electrode (illustrated as electrode(s) 112) and at least one sensor (illustrated as sensor(s) 114) can be embodied in the wearable device 110 (e.g., as surface electrodes/sensors). System 200 includes a controller 118 that communicates with the simulation device 120 (may be part of the simulation device 120) and the signal generator 116, while in system 100 functionality of the controller can be embodied in the signal generator 116. The at least one electrode can receive the electrical signal from the signal generator 116 in response to an action and/or event in the simulated environment and the at least one sensor can send feedback (e.g., indicative of position and/or movement of the user) to the signal generator 116 (see FIG. 1) and/or the controller 118 (see FIG. 2), where at least the feedback (feedback from one or more other sources can also be used) can cause another action and/or event and/or a continuation of the action and/or event in the simulated environment (as a control loop). As an example, the at least one electrode can be positioned to apply the at least one electrical signal to the user to cause a referred sensation that at least mimics the sensation that would be felt in real life (or a safe alternative) because of an action and/or event of the simulated environment. The referred sensation can occur when the electrode is positioned at one location (more proximal on the user) that delivers a stimulation to cause a sensation to be felt at a different location (more distal on the user). The same nerve can run through the one location and the different location. The referred sensation can be tactile sensations, such as a touch force, pain, heat, or the like, or sensations related to muscle force or tension, or joint position or movement. In some instances, the control loop can be continued until an entire simulation in a simulated environment is ended (potentially including more than one action/event). In other instances, the control loop can end after the action/event (including only a single action/event). Additional information about referred sensation can be found in International Serial No. PCT/US2023/25046, entitled “SURFACE ELECTRICAL NERVE STIMULATION DELIVERED AS HAPTIC FEEDBACK TO CAUSE A USER TO EXPERIENCE NATURAL SENSATION” incorporated by reference in its entirety herein.

Shown in dashed lines in both FIG. 1 and FIG. 2, the simulation device 120 can be any device capable of embodying/displaying a simulated environment (e.g., a remote environment, an extended reality (XR) environment, an augmented reality (AR) environment, a virtual reality (VR) environment, a mixed reality (MR) environment, a veridical environment located remote from a user, or the like). While not shown, the simulation device 120 can include one or more: memories, processors, user interface devices, visual displays, speakers, associated circuitry and power elements, or the like. For instance, the simulation device 120 can also include a headset (or other device). In another instance the simulation device 120 can also include a system for teleoperation of and/or including a remote device (e.g., a drone, a robot, a surgical robot, a motorized vehicle, etc.). The simulation device 120 can include at least visual and/or audio to the user. The simulation device 120 can be in wired and/or wireless (e.g., WIFI, Bluetooth, etc.) communication with the signal generator 116 (FIG. 1) and/or the controller 118 (FIG. 2).

In systems 100, 200, based on information from the simulation device 120 and/or the controller 118 (e.g., indicating that an event/action has occurred/is occurring and the location/intensity of the action), the signal generator 116 can generate an electrical signal and deliver the electrical signal to a predetermined one or more of the at least one electrode to deliver the haptic feedback to the user. The electrical stimulation can create a referred sensation in the user, where electrical nerve stimulation can be delivered to a sensory nerve at a first area of a user's body to induce a second area of the user's body to experience a natural sensation due to an afferent action potential transmission from a peripheral sensory nerve to the spinal cord and up to the brain, which perceives the action potentials as sensory information from the second area. The at least one sensor can provide feedback (e.g., position information corresponding to at least a portion of the user's hand) to the signal generator 116 in FIG. 1 and/or to the controller 118 in FIG. 2. Additionally or alternatively, the feedback can also be provided to the simulation device 120.

An action/event can occur in the simulated environment (can be done to, done by, or somehow effect the user) and an indication of the action/event can be sent from the simulation device 120 to the signal generator 116 (FIG. 1) and/or the controller 118 (FIG. 2) according to a wired and/or wireless communication pathway (either as the action/event occurs or after the action/event occurs). The signal generator 116 (FIG. 1) and/or the controller 118 (FIG. 2) can determine parameters for the stimulation (e.g., location, intensity, type, and the like) based on the indication received from the simulation device 120. The signal generator 116 can generate a waveform (with the parameters) that can be sent to one or more electrodes of a wearable device for sensory stimulation (so that the user feels the action and/or a representation of the action/event). The waveform can, for instance, include a pattern and/or train of pulses, where each pulse and/or grouping of pulses can have one or more same or different parameters. As an example, the one or more parameters can include (but are not limited to) pulse width, frequency, amplitude, pulse shape, interpulse interval, recharge phase amplitude, recharge delay, etc. The type of stimulation referenced herein can include patterned stimulation intensity (or Ψ stim), which can refer to a variation of one or more stimulation parameters so that a pulse or pattern of pulses in a stimulation signal can provide and/or reflect a certain intensity and/or aspect of the action. For example, the patterned stimulation intensity can include a stimulation waveform (also referred to as the electrical stimulation) having a pulse amplitude (PA) and a pulse width (PW). During calibration of the system the PA can first be adjusted to achieve a maximum pulse width (PW) range inside the capabilities of the stimulators (e.g., skin surface electrode(s)).

As an example, during use of the system 100, 200 the pulse width (PW) of the stimulation waveform can be adjusted to modulate the intensity of the referred sensations based on the action at the time (e.g., the user's hand's interactions with virtual and/or remote objects), the frequency of the stimulation waveform can be adjusted to modulate the frequency of the referred sensation (e.g., continuous or tapping sensation and speed of taps), and the symmetry and shape of the stimulation waveform can be changed (by the controller 118) to modulate the quality of the referred sensation being felt based on the action. The parameters can also reflect a location of the action/event, and/or a nature of the action/event, and/or a duration of the action/event. The signal generator 116 and/or the controller 118 can change at least one of the one or more parameters in response to the action or the intensity of the action in the simulated environment changing over time. The signal generator 116 and/or controller 118 can, additionally or alternatively, choose which of the one or more electrodes 112 should deliver the electrical stimulation so that the proper area of the body receives the haptic feedback as a referred sensation. It should be understood that while electrical stimulation is referred to in the singular, one or more electrical stimulations having the same and/or different parameters can be simultaneously, overlappingly, and/or separately applied via the one or more electrodes 112.

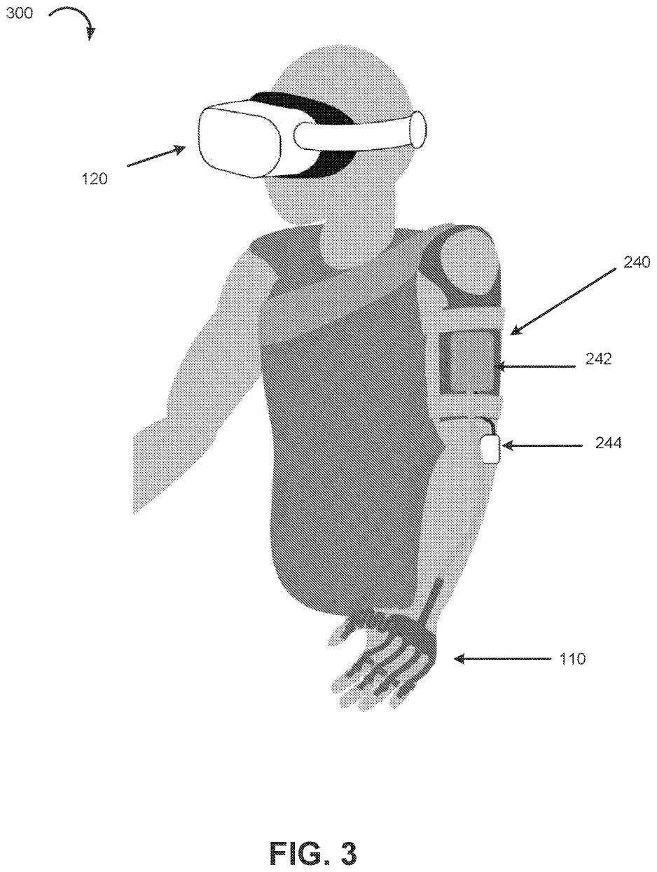

An example 300 use of the systems 100, 200 shown in FIGS. 1 and 2 is shown in FIG. 3. In the example, a headset can be worn that embodies the simulation device 120. The headset can be worn on a head and over the eye(s) of the user to provide at least a portion of a simulated environment to the user. In some instances, the headset can be a XR, AR, VR, or MR device and/or can be connected (in communication) with a remote device. The example 300 can also include at least an arm band 240 that can be removably positioned on at least a portion of an arm of the user. The arm band 240 may include and/or be a portion of a larger upper body wearable (e.g., that can be positioned on a shoulder, around a portion of a chest, etc. of the user). The arm band 240 can hold/include the signal generator and the controller (e.g., the signal generator 116 and/or the controller 118) and a common return and/or ground electrode 244 connected to each other and the wearable device through an interface PCB 242. The arm band 240 can include one or more removable attachment mechanisms (e.g., straps, Velcro, elastic, etc.). The common return and/or ground electrode 244 can be positioned on a portion of the body of the user remote from the hand of the user and/or remote from the electrode(s) 112. The wearable device 110 (shown as a glove-like article) can communicate with the signal generator 116 and/or the controller 118. Additionally, and/or alternatively the signal generator 116 and/or the controller 118 could be placed in, placed on, and/or attached to a pocket, a bag held by the user, a belt, or on a nearby surface (e.g., table, etc.) to the user.

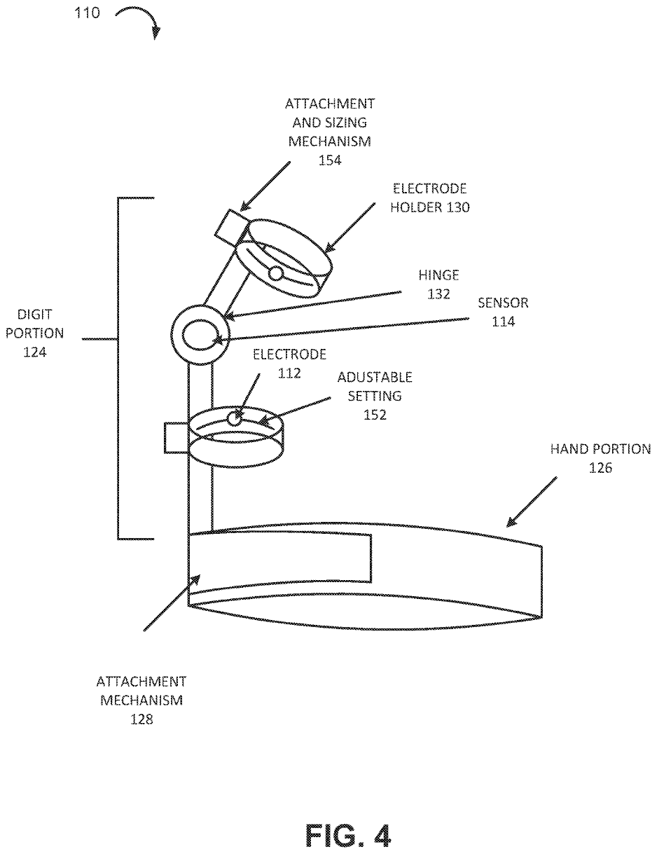

FIG. 4 is a diagram showing at least a portion of the wearable device 110. As noted, the wearable device 110 can be an adjustable, re-usable wearable accessory that is low profile and light weight and can enhance a simulated environment by providing referred sensation of an action to a user via electrical stimulation and improved position information. The wearable device 110 can include a hand portion 126 and at least one digit portion 124 (one digit portion is shown in FIG. 3 for simplicity of illustration/explanation). At least a portion of the hand portion 126 and/or the digit portion 124 can be re-sizeable to facilitate the reusability of the wearable device. Additionally, at least a portion of the hand portion 126 and at least a portion of the at least one digit portion 124 can include a PCB (or other substrate structure) that is flexible and at least partially holds at least one flexible conductor, as well as additional materials and/or components that add to its low profile and light weight nature. The PCB can ensure that the hand portion and the digit portion can be contiguous and/or can be mechanically and electrically connected. The PCB can include one or more flexible substrate materials (e.g., polyimide, polyester, polyethylene naphtholate, polyethylene terephthalate, etc.) that can allow the flexible PCB to bend and deform before returning to an original shape and one or more conductive materials.

The hand portion 126 can be, for instance, a strap that can extend around a portion of the palm and back of a hand. The hand portion 126 can include/be coupled to at least one attachment mechanism 128 that can anchor the hand portion to the hand of the user. The hand portion 126 can be, for example, a band around the back and palm of a hand, a body of a glove, or the like capable of being worn on at least a portion of a hand. The hand portion 126 can include one or more mechanisms to facilitate resizing including an attachment mechanism 126. The attachment mechanism 128 can be, for instance, a Velcro strap, one or more snap and/or button closures, an elastic, or the like. The attachment mechanism 128 can be re-sized by tightening or loosening. The hand portion 126 can additionally and/or alternatively include a material that can expand and/or contract to fit a portion of a hand (e.g., like spandex).

The at least one digit portion 124, which can be contiguous with the at least one hand portion 126, can be worn on at least a portion of a digit of a hand. Each of the at least one digit portions 124 can include, for example, a backbone-like portion that can at least extend along a length of a digit, at least a portion of a glove finger, or the like. Each of the at least one digit portions 124 can include at least one electrode 112 (e.g., skin surface electrode), at least one electrode holder 130 (which may be re-sizeable), and optionally at least one hinge 132 that can include at least one sensor 114. Although the hinge 132 is shown described as being a part of the digit portion 124, it will be understood that the hinge 132 is intended to be optional. The at least one electrode 112 can be electrically connected to the flexible PCB of the digit portion 124 and can be positioned to be in close contact (e.g., touching and or near) an area of the user's skin (e.g., including at least one digital nerve) to provide the electrical stimulation to cause a referred sensation in another portion of the hand (e.g., at a more distal portion of a given digit). The at least one electrode holder 130 can be flexible PCB and can be connected to and/or contiguous with the flexible PCB of the rest of the at least one digit portion 124 (e.g., attached to the backbone portion or incorporated into at least a portion of a glove finger. The at least one electrode holder 130 can be re-sizable (e.g., at least one of tightened, loosened, moved proximal, moved distal, or the like). For instance, each electrode holder 130 can enable adjustment of the at least one electrode 112 to positions on a proximal-distal axis of the digit. The at least one electrode holder 130 can encircle at least a portion of the digit and hold each of the at least one electrode close to the skin of the user with an adjustable electrode setting (not shown). The adjustable electrode setting can include a track and anchoring mechanism for positioning the electrode at a radial position on the digit. It should be noted that a majority of the adjustability of the electrodes is in the medial-lateral (e.g., radial) direction due to the electrode track on which the electrode can slide (and then be secured). Positioning in the proximal-distal direction is possible by adjusting the mounting devices to tighten down the electrode holder into a different position. The at least one hinge 132 can be connected to the flexible PCB (e.g., connecting two or more portions of flexible PCB, connected to contiguous portions of flexible PCB, or the like) and positioned near at least one knuckle of the digit (each). The at least one hinge 132 can include at least one sensor 114 that can measure a location, flexion angle, and/or a rotation of at least a portion of the digit. The wearable device 110 is shown with a single digit portion 124 with a single hinge 132 and two electrode holders 130 (with an electrode 112) for ease of illustration but should be understood to be able to include more hinges, for example three hinges corresponding to knuckles of fingers, and any numbers of electrode holders 130. Additionally, the wearable device 110 may not include any hinges 132 (e.g., may include no hinges).

Each of the electrode holders 130 can also be positioned, and re-positioned, along a distal-proximal axis of a digit and secured. Additionally, the electrode 112 of an electrode holder 30 can be positioned with an adjustable setting around a radial axis of the digit. The adjustable setting 152 can be for example, a track for the electrode 112 built into at least a portion of the electrode holder 130 that can at least approximately, partially encircle the digit. For instance, the radial position of the at least one electrode 112 on the digit can be adjusted along the digit to maximize desirable target sensation and minimize undesirable sensations when the electrical stimulation is applied through that at least one electrode. The adjustable setting 152 can include a securement mechanism (not shown, such as a screw-type device, a gripping device, a tightening device, or the like) to secure the electrode 112 in place when a preferred radial position has been determined. Each electrode holder 130 can include an electrically insulated portion (not shown) that can electrically insulate the electrode 112 from an environment of the user.

Optionally, the digit portion 124 can further include one or more hinges (one hinge 132 shown and discussed). The hinge 132 can be positioned near a knuckle of the digit to give additional freedom of movement to a user. In one instance, the hinge 132 can mechanically and/or electrically connect two or more portions of flexible PCB of the digit portion 124. In another instance, the hinge 132 can be positioned on a contiguous portion of flexible PCB. The hinge 132 can include one or more sensors 114. For instance a sensor 114 can be an integrated encoder (e.g., digital or analog) that can measure a bend angle of a knuckle. For instance, the integrated encoder can include a rotary encoder configured to measure a rotation of the hinge 132. In another instance (additional or alternative) the sensor 114 can be an ancillary marker for an optical sensor/system of a simulation device (e.g., a remote device, an AR device, a VR device, and/or an XR device) in communication with the signal generator and/or wearable device to track a position of the hand when in view from an optical capture portion of such a simulation device.

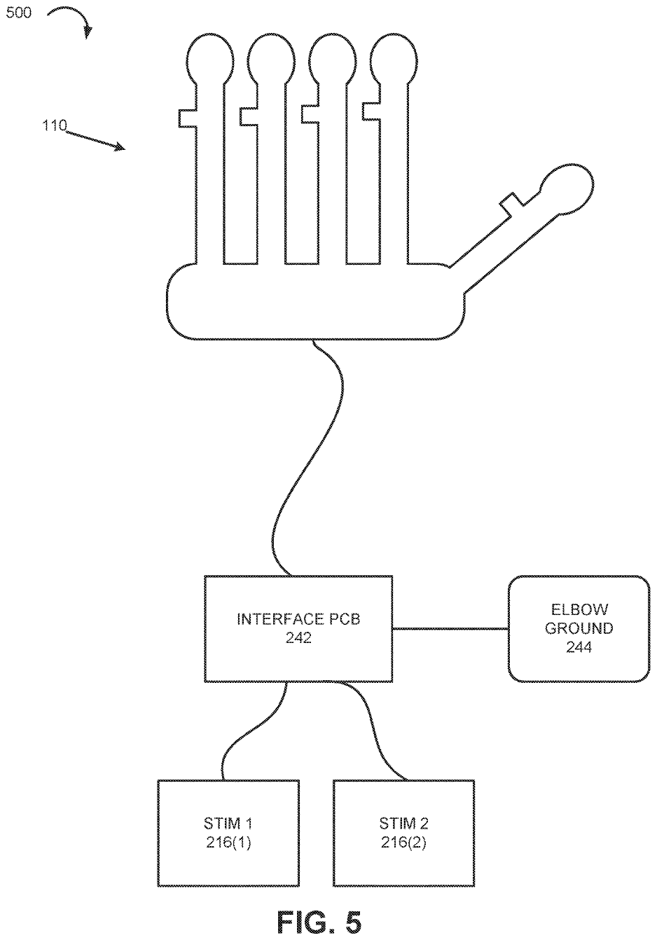

FIG. 5 shows a diagram illustration 500 of an example of the wearable device 110 having five digit portions and a hand portion connected to an interface PCB 242. The interface PCB 242 can also be connected to at least an elbow ground electrode 244 and to one or more stimulation generators, shown as two, STIM 1 216(1) and STIM 2 216(2) for configuring and sending stimulation to the wearable device 110. Although shown as including a single portion with five finger portions, it should be understood that the flexible PCB may be contiguous material and/or split into separate portions that are structurally and/or electrically connected and may have any number of digit portions greater than or equal to one. It should be noted that flexible PCB(s) can bend and twist with improved reliability with a reduced size and weight and an increased design flexibility. It should also be noted that the ground electrode can be positioned on other portions of the user such as the shoulder, trunk, or on a portion of the hand, foot, or limb not directly being stimulated.

FIG. 6 shows pictures of an example wearable device. FIG. 6, element A shows the palm-side view of the wearable device and FIG. 6, element B shows the back of the hand-side view of the wearable device. The wearable device can be primarily composed of flexible PCB that can conform to the curvature of the hand and digits (fingers and thumb) and can bend between the fingers to mount vertically. The digit portions can be longer paths extending from the comparatively shorter hand portion down towards the tips of the finger to accommodate a greater variety of finger lengths and hand sizes. Such accommodations can include modifying where the hand portion is worn on the proximal/distal axis of the hand (e.g., closer or further from the wrist). The wearable device can include at least one stretch element and at least one bracing element configured to accommodate different hand and/or finger sizes as well. Textile fastener components (e.g., attachment mechanisms) can adjust to a variety of hand and finger sizes and can be optimized for reduced don and doff time while maintaining a secure fit on and around any hand. Optionally, a hinge adjacent to at least one phalange adjacent joint (e.g., knuckle) on a lateral or medial side can also facilitate natural hand motion and increase user comfort. It should be noted that this example of a wearable device is fingertip-less to not impede the user's ability to feel and pick things up in the real world while using the wearable device. The wearable device can fit close to the skin and can include at least one color and/or material that is low visual contrast to facilitate visual tracking (discussed in greater detail below).

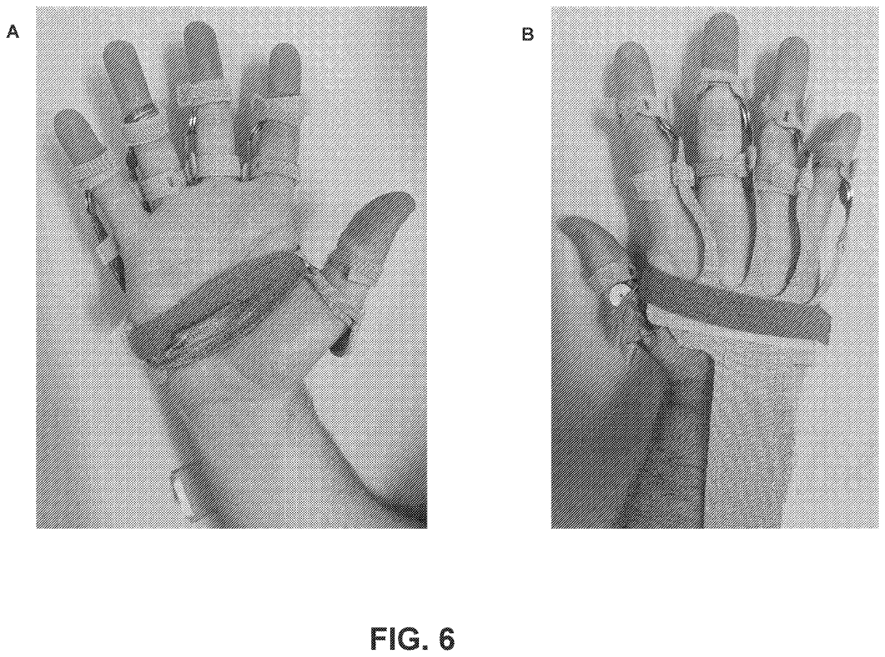

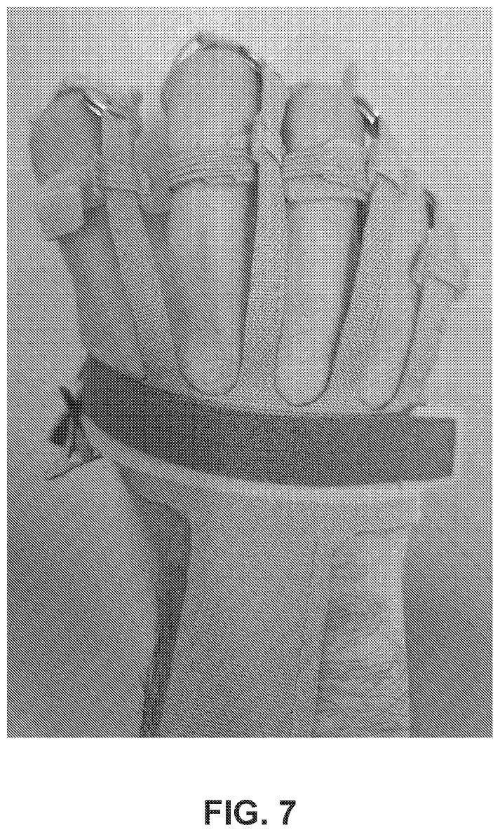

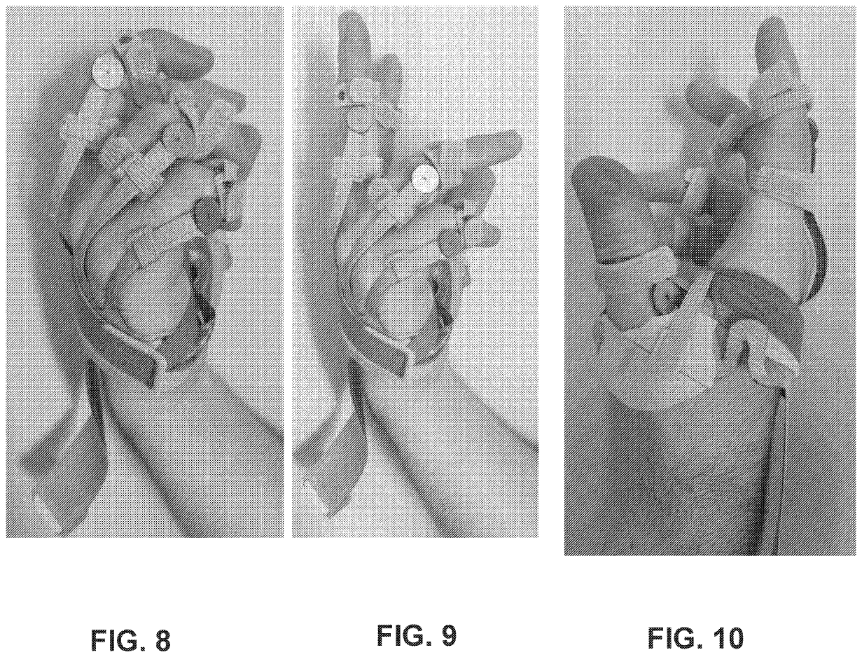

FIGS. 7, 8, 9, and 10 shows a user wearing the wearable device while holding the hand at a plurality of different hand positions. The electrode(s) deliver the stimulation leading to a referred sensation and the sensor(s) deliver information regarding the position of the hand. FIG. 7 shows a user of the wearable device making a fist. The wearable device fits close to the user's hand such that the fist gesture is clearly visible. The Velcro strap attachment mechanism of the hand portion that can be tightened or loosened can be seen crossing over the back of the hand in the medial lateral directions. Several electrode holders of the digit portions can also be seen. The electrode holders can include Velcro straps, an elastic material, and a sliding mechanism for tightening/loosening the electrode holders and moving the electrode holders up and down (on a proximal/distal axis) a digit. Hinges can be seen near the proximal interphalangeal joints (however, not necessary). FIGS. 8, 9, and 10 show the wearable device with the hand and fingers rotated and bent in various directions to display other angles and/or aspects of the wearable device.

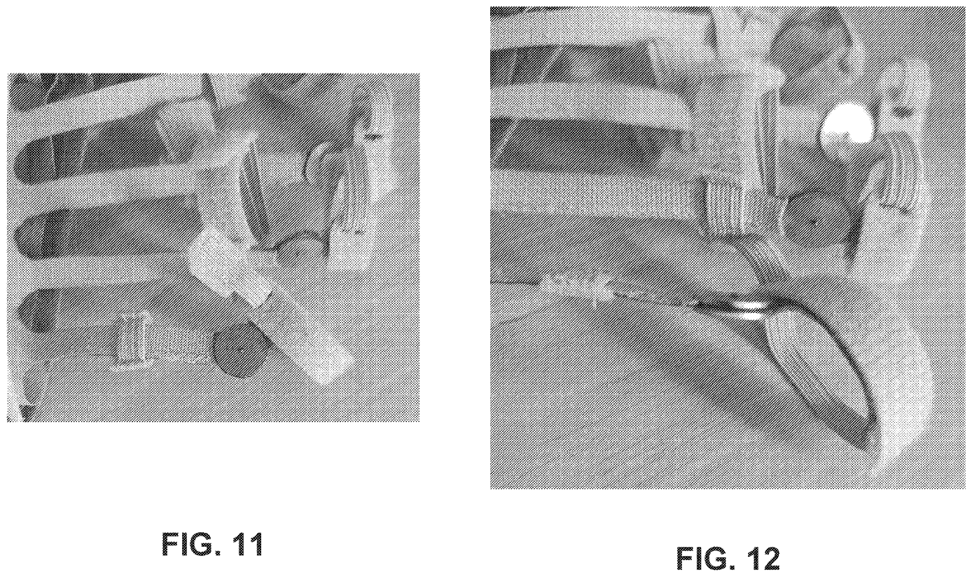

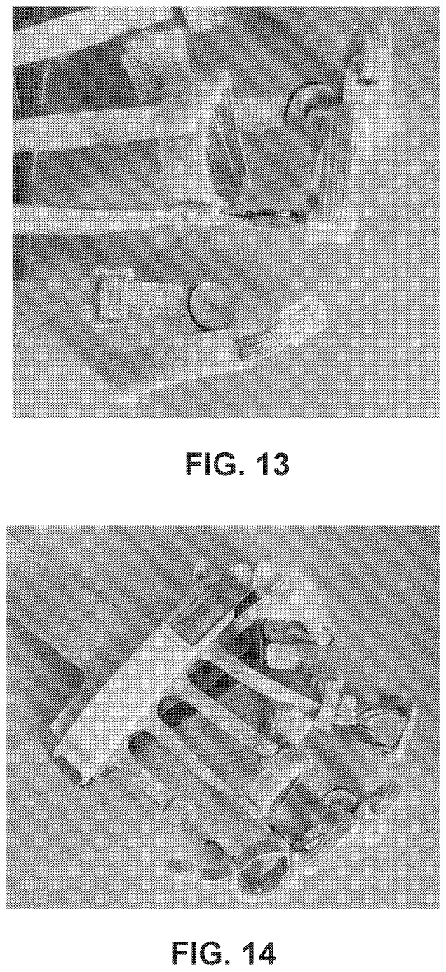

FIGS. 11, 12, and 13 show the digit portions in greater detail (zoomed in photographs while the device was not being worn). In FIG. 11, it can be seen that each of the digit portions can be a different length and can include one or more electrode holders. As shown in FIGS. 11, 12, and 13 each of the electrode holders includes a stretch element and an attachment mechanism (e.g., Velcro) for positioning around a digit. At least one of the electrode holders on at least one of the digit portions can be moved on a proximal distal axis of a digit portion using another stretch element The hinge as shown prominently in FIGS. 12 and 13 can include at least two portions that can sandwich a portion of the flexible PCB not covered by the fabric coating. A hinge can allow bending of at least one digit portion between approximately 0° and 360° relative to the proximal portion of the at least one digit portion (and any angle in between).

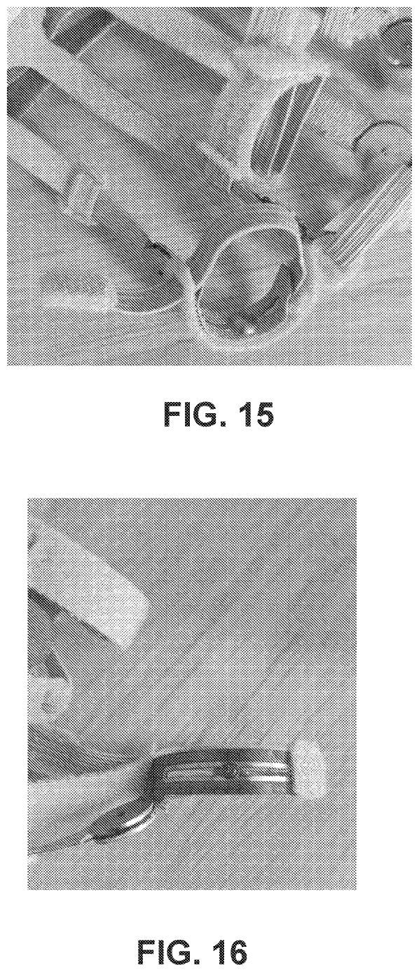

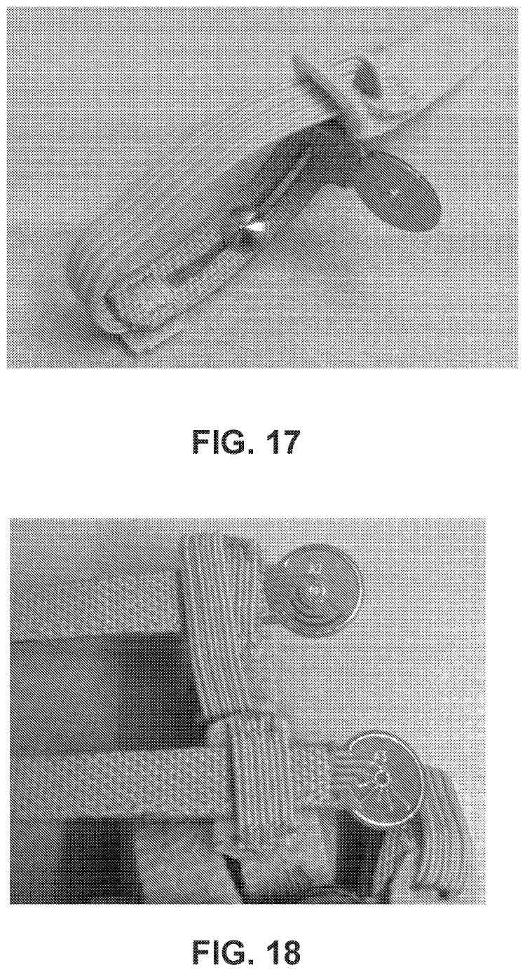

FIG. 14 shows a back of the hand view of an example of the wearable device when not worn by a user. To maintain a comfortable skintight profile, the wearable device can be constructed of primarily thin materials (e.g., depth of less than 1 cm, less than 5 mm, less than 1 mm, or the like). The wearable device can be made of a single flexible PCB, without the addition of bulky and high profile devices, such as bend sensors, wire, and connectors, so as to not detract from the haptic experience. Additional textile components, as shown, can be added to the wearable device to secure the flexible PCB as closely to the hand as a glove while remaining light and experientially invisible (e.g., not significantly effect hand and/or arm movements and use during a simulation). For instance, the signal generator(s) and other electronic components can be secured to more proximal areas of the body (such as a forearm, elbow, shoulder, torso, etc.), not shown in FIG. 14, to limit the weight on the hands and keep the experience comfortable. Both the hand portion and each of the five digit portions can be seen with stretch and bracing elements, attachment mechanisms, hinges, electrode holders, and the like. For instance, each of the digit portions can include at least one electrode (e.g., each in a separate electrode holder) for stimulation of each digit. As shown here, the thumb digit can be shaped differently from the other finger-digit portions. The thumb digit portion can include a wider bracing element and a non-straight PCB portion connecting to the hand portion for increased flexibility/mobility of the thumb compared with the fingers and/or for enhanced strain relief of the thumb digit portion to reduce breakage. The inner portions of several electrode holders and the accompanying electrodes can be seen. For each electrode holder the electrode is held in a track for radial movement around a given digit. This flexibility in selection of electrical stimulation location allows users to maximize desirable target sensations while minimizing undesirable ones. The electrodes can have a convex curvature that can press into the skin of the user to ensure sufficient contact for delivery of the stimulation. The electrode holders are described in more detail with respect to FIGS. 15 and 16. The hinges are described in more detail with respect to FIGS. 17 and 18.

As shown in more detail in FIG. 15, the electrode can have a convex curvature to better press into the skin of the user (e.g., make better physical contact) (this convex curvature is also seen, for example, in FIG. 17). The electrode can deliver electrical currents (e.g., the stimulation) to the digital nerve(s). The electrode can be any type of electrode that can be safely used to deliver an electrical signal through a user's skin. For example, the electrode can be made of a material that can deliver an electrical signal through the patient's skin and prevent build-up of high charge concentrations that could be irritating or damaging to the skin. The electrode can remain chemically inert to prevent undesirable experiences, such as but not limited to, irritation and uncomfortable sensation. The radial location of the electrode can be changed, as shown on FIGS. 15 and 16, to allow the user to position the electrode in a location unique to their needs (e.g., based on calibration). This flexibility in selection of electrical stimulation location allows users to maximize desirable target sensations while minimizing undesirable ones. FIG. 16 shows the exterior of an electrode holder, with a layer of fabric on the outside removed to display the adjustable setting for moving the electrode radially. The adjustable electrode setting can be electrically insulated from the environment for safety and to prevent unintentional stimulation not through the electrode. The fabric components (as shown in FIG. 15) can, in some instance, be the insulation for the adjustable electrode setting. An anchor can be included in the adjustable electrode setting to keep the electrode at a given radial location that has the most desirable results during calibration.

FIGS. 17 and 18 show different views of a portion of hinges of the wearable device, which can include at least one sensor, in relation to the electrode holder (FIG. 17) and the electrode holder and the elongated digit portion (FIG. 18). The hinges can be positioned at phalange adjacent joints to accommodate more natural hand motion and increase comfort of wearing and/or using the wearable device. Each of the hinges can include at least one sensor to aid in motion tracking of the wearable device. In many cases, current XR, AR, VR, MR, and teleoperation system's optical-based hand tracking functions can have difficulty accurately and reliably tracking certain hand positions when users have a wearable device on a hand, particularly when portions of the hand and/or fingers are occluded from a capture portion of the system's field of view (e.g., by parts of the user's body, objects in the environment, etc.) The at least one sensor, as shown in both FIGS. 17 and 18, can be a rotational encoder integrated into the hinge. The rotational encoder can measure a relative angle of a joint the hinge is positioned at and can communicate the relative angle to an associated controller (e.g., controller of the signal generator and/or the simulation device). The relative angle can be measured by a swiper selecting from a plurality of discrete and/or continuous outputs depending on the angular position of the two flex PCB components of the digit portion running up/down the digit relative to the rotational encoder. The relative angle can be a source for hand tracking information that can be fed into the hand-tracking program of the simulation device to correctly register the hand position and/or act as a backup in case the optical hand-tracking (if available) fails. As another example, the output can be a continuous output when the swiper is positioned at any position along a continuous track, For instance, the sensor in the at least one hinge of the at least one digit portion of the wearable device can be an ancillary marker for an optical sensor of a remote device, an AR device, a VR device, and/or an XR device in communication with the system to track a position of the hand. The rotational encoder can have a minimal profile and weight and can provide robust data to the controller while being minimally invasive to a user's overall haptic experience.

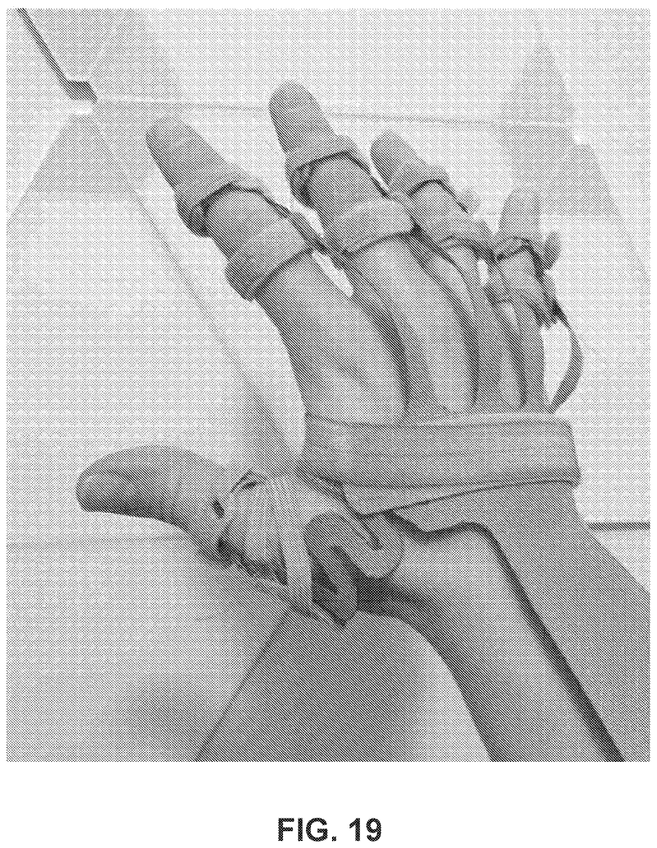

To further aid visual tracking of the hand (e.g., improve reliability and accuracy), the wearable device can fit close to the skin of the hand and can include materials that are at least one color and/or types of materials that are low visual contrast to a simulation device's optical tracking system. FIG. 19 shows an example of a gray-scale view of the wearable device from an optical tracking system of a stimulation device worn by the user. The wearable device can have a low contrast color profile to reduce the likelihood that the visual presence of the wearable device will confuse optical tracking programs designed to identify hand shaped objects. For example, green and orange can have a similar intensity to at least lighter skin colors (e.g., Caucasian) in grey-scale and can be considered a low contrast color profile. In an instance the components of the wearable device can be designed to be positioned on a hand in a manner that the wearable device can be at least partially hidden from the viewing angles of optical tracking technologies. High contrast components that cannot be hidden from the camera's view can be laminated under an experimentally determined low-contrast textile, making the accessory nearly invisible to a contrast based and/or grayscale optical-tracking program, regardless of what color the textile is to the human eye. In other instances, the wearable device can have a minimal coverage design that can cover as little of the hand and/or digits as possible.

### IV. Methods

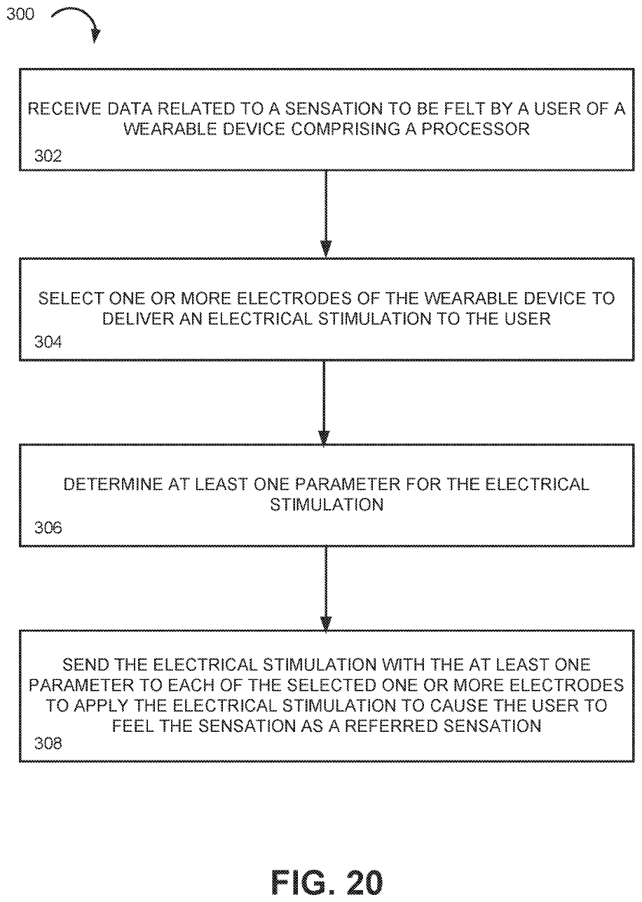

Another aspect of the present disclosure can include methods 300, 400, and 500 (FIGS. 20-22) for using a re-usable, re-sizable, and wearable device (e.g. wearable device 110) to deliver the stimulation to provide haptic feedback in response to an action occurring in a simulated environment (e.g., a remote environment, an extended reality (XR) environment, an augmented reality (AR) environment, a virtual reality (VR) environment, a mixed reality (MR) environment, a veridical environment located remote from a user, or the like). The methods 300, 400, and 500 can utilize a system (shown in FIGS. 1-19) to deliver surface electrical nerve stimulation to cause a user to feel referred, natural sensation as haptic feedback. At least one step of each of the methods can be executed by at least one component that includes at least a processor.

For purposes of simplicity, the method is shown and described as being executed serially; however, it is to be understood and appreciated that the present disclosure is not limited by the illustrated order as some steps could occur in different orders and/or concurrently with other steps shown and described herein. Moreover, not all illustrated aspects may be required to implement the method, nor is the method necessarily limited to the illustrated aspects.

Referring now to FIG. 20, illustrated is a method 300 for causing a referred sensation in a user of a system including a re-usable wearable device (also referred to simply as wearable device), a signal generator, and a simulation device in response to an action in the simulation. At 302, a controller of (or associated with) the wearable device can receive data related to a sensation to be felt by a user of the wearable device from an external device (e.g., the simulation device). The external device (e.g., the simulation device) can be a remote device (e.g., teleoperation system), an AR device, a VR device, an MR device, and/or an XR device). The data related to the sensation to be felt by a user of the wearable device can be related to a virtual touch experience of the user controlled by the remote device, the AR device, the VR device, or the XR device. For instance, the virtual touch experience can include, but it is not limited to, picking up a virtual object, catching a virtual object, physically interacting with a virtual being (or virtual avatar of a real person), a physical response to a real world action of a remote device, or the like.

The wearable device can be re-usable by one or more users. The wearable device is described herein with reference to at least a hand but it should be understood this is non limiting and the wearable device can be configured for a foot and/or can include a wrist/ankle, arm/leg, etc. The wearable device can include at least one flexible PCB, which can be a backbone for a hand portion and at least one digit portion. The hand portion and the digit portion(s) can be re-sizable to fit a variety of different users. The hand portion and the digit portions can, for instance, include at least one stretch element and/or attachment mechanism (e.g., straps, Velcro, snaps, button, etc.) for tightening, loosening, and/or moving one or more components. The hand portion can be worn on at least a portion of a hand of a user and the stretch elements and/or attachment mechanism can anchor the hand portion to the user's hand. Each of the at least one digit portions can be worn on at least a portion of a digit and the stretch elements and/or attachment mechanism can anchor the digit portion to the given digit. Each of the digit portions can additionally include at least one electrode and an electrode holder that can hold each of the at least one electrode. The at least one electrode can be connected to the flexible PCB backbone of the wearable device and can be positioned in close contact with an area of the user's skin (on a digit) to provide electrical stimulation causing a referred sensation in another portion of the hand and/or digit. The electrode holder can be connected to the flexible PCB backbone of the wearable device and can include the one or more stretch and/or attachment mechanisms of the digit portion to help hold the electrode close to the skin. The electrode can be held in an adjustable electrode setting that can include a track and an anchoring mechanism for positioning the electrode at a radial position on the digit. Each electrode holder can enable adjustment of the at least one electrode to positions on a proximal-distal axis of the digit (e.g., along a length of the flexible PCB position approximately along the proximal-distal axis of the digit).

At 304, one or more electrodes of the at least one electrode can be selected to deliver the electrical stimulation to the user at a location of each of the selected one or more electrodes. The other portion of the hand and/or digit where the referred sensation is caused can be one or more locations remote from the selected one or more electrodes. The one or more locations remote from the selected one or more electrodes can be, for instance, one or more fingertips of the user, allowing the user to experience a multi-reality interactivity providing virtual interaction with virtual objects and direct interaction with real world objects. At 306, at least one parameter for the electrical stimulation to be delivered to each of the selected one or more electrodes can be determined based on the data related to the sensation. As an example, the at least one parameter can include (but are not limited to) pulse width, frequency, amplitude, pulse shape, interpulse interval, recharge phase amplitude, recharge delay, etc. as described above in more detail. At 308, the electrical stimulation with the at least one parameter can be sent to each of the selected one or more electrodes to apply the electrical stimulation to cause the user to feel the referred sensation in the other portion of the hand. In some instances one or more electrical stimulations (with the same or different at least one parameters) can each be sent to different electrodes to create a multi-touch feeling in the user (e.g., different parts of a hand feel different things in accordance with a more natural feeling).

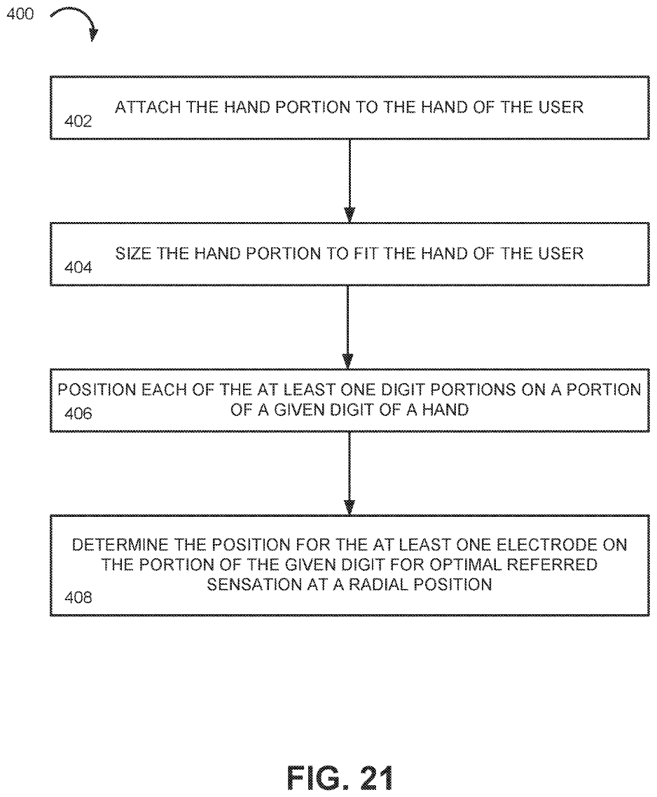

Referring now to FIG. 21, illustrated is a method 400 for arranging the wearable device on a user's hand. At 402, the hand portion of the wearable device can be attached to the hand of the user. The attachment mechanism(s) can be loosened and/or the stretch elements stretched, as needed, to fit over the hand and/or digits of the user and. Then, at 404, the hand portion of the wearable device can be sized to fit the hand of the user. The attachment mechanism of the hand portion can be tightened and/or loosened further to fit snuggly to the hand (e.g., around the back of the hand and the palm. At 406, each of the at least one digit portions of the wearable device can be positioned on the portion of the given digit of the hand and fit to the digit (e.g., with stretch element(s) and/or attachment mechanism(s). The hand portion can be re-adjusted to position the digit portions if needed (e.g., was initially positioned too proximal or too distal on the hand for the digit portions to be positioned properly). At 408, the position for the at least one electrode on the portion of the given digit for optimal referred sensation at a radial position on each digit can be determined.

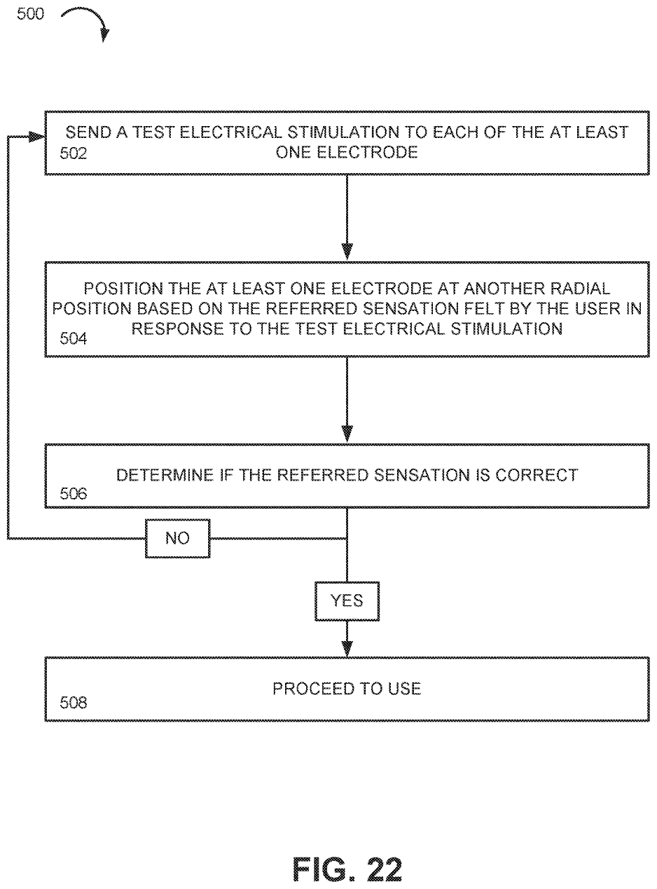

Referring now to FIG. 22, illustrated is a method 500 for calibrating the wearable device for a user such that the at least one electrode is positioned for optimal referred sensation at a radial position on each digit. At 502, one or more test electrical stimulations can be sent from a controller (e.g., of and via the signal generator associated with the wearable device) to each of the at least one electrode at a starting radial position and/or distal/proximal position. The one or more test electrical stimulations can have known parameters with an expected referred sensation if the electrode(s) are positioned at a proper radial position and/or distal/proximal position on the digit(s). At 504, the at least one electrode can be positioned at another radial position and/or distal/proximal position based on the referred sensation felt by the user after application of the one or more test electrical stimulations. At 506, a determination can be made if the referred sensation is correct (e.g., is the expected referred sensation for the test electrical signal(s)). If the referred sensation is the correct referred sensation for each of the at least one electrodes, then at 508, the system can proceed to a usable state (e.g., the wearable device is calibrated and ready for gaming, teleoperation, virtual social interaction, etc.). If the referred sensation in one or more electrodes of the at least on electrodes is determined to be incorrect, then the calibration for that one or more electrodes can restart with different test stimulations and/or different positions of the one or more electrodes.

From the above description, those skilled in the art will perceive improvements, changes, and modifications. Such improvements, changes and modifications are within the skill of one in the art and are intended to be covered by the appended claims.

The following is claimed:

1. A system comprising:
a re-usable wearable device comprising a flexible PCB, further comprising:
a re-sizable hand portion configured to be worn on at least a portion of a hand of a user and comprising an attachment mechanism to anchor the re-sizable hand portion to the hand of the user, and
at least one re-sizable digit portion, each digit portion configured to be worn on at least a portion of a digit of the hand and comprising:
at least one electrode connected to the flexible PCB and configured to be positioned in close contact with an area of the user's skin to provide electrical stimulation causing a referred sensation in another portion of the hand, and
an electrode holder connected to the flexible PCB and configured to hold each of the at least one electrode close to the skin with an adjustable electrode setting, wherein each electrode holder is configured to enable adjustment of the at least one electrode to positions on a proximal-distal axis of the digit, and wherein the adjustable electrode setting comprises a track and anchoring mechanism for positioning the electrode at a radial position on the digit, and
a signal generator connected to the wearable device and configured to send an electrical signal configured to be used for the electrical stimulation causing the referred sensation to the at least one electrode.

2. The system of claim 1, further comprising a controller configured to communicate with at least the signal generator and the wearable device.

3. The system of claim 2, wherein the controller is further configured to communicate with a remote device, a VR device, an AR device, and/or an XR device.

4. The system of claim 2, wherein the system further comprises an arm band configured to be removably positioned on at least a portion of an arm of the user, wherein the arm band comprises the signal generator and the controller.

5. The system of claim 1, wherein the wearable device is configured to fit close to the skin without restricting movement and comprises at least one color and/or material that is low visual contrast to facilitate visual tracking.

6. The system of claim 1, further comprising at least one hinge connected to the flexible PCB and positioned near a knuckle of the digit and comprising a sensor configured to measure a location and/or rotation of at least a portion of the digit; and
wherein the sensor in the at least one hinge further comprises an integrated encoder, wherein the integrated encoder is configured to measure a bend angle of a knuckle.

7. The system of claim 6, wherein the integrated encoder comprises a rotary encoder configured to measure a rotation of the at least one hinge.

8. The system of claim 6, wherein the sensor in the at least one hinge of the at least one digit portion of the wearable device is further configured as an ancillary marker for an optical sensor of a remote device, an AR device, a VR device, and/or an XR device in communication with the system to track a position of the hand.

9. The system of claim 1, wherein each of the at least one electrode is configured with a convex curvature configured to press into the skin of the user.

10. The system of claim 1, wherein each of the electrode holders are configured to encircle a portion of the digit and to be re-sizably fit to the portion of the digit.

11. The system of claim 1, wherein each of the electrode holders comprises an electrically insulated portion configured to electrically insulate the electrode from an environment of the user.

12. The system of claim 1, wherein the radial position of the at least one electrode on the digit is adjustable along the digit to maximize desirable target sensation and minimize undesirable sensations when the electrical stimulation is applied through that at least one electrode.

13. The system of claim 1, wherein the wearable device comprises at least one stretch element and at least one bracing element configured to accommodate different hand sizes.

14. The system of claim 1, further comprising a common return electrode positioned on a portion of a body of the user.

15. A method comprising:
receiving, by a controller of a re-usable wearable device, data related to a sensation to be felt by a user of the wearable device from an external device, wherein the wearable device is re-usable and comprises a flexible PCB, the wearable device further comprising:
a re-sizable hand portion configured to be worn on at least a portion of a hand of a user and an attachment mechanism to anchor the re-sizable hand portion to the hand of the user, and
at least one re-sizable digit portion, each digit portion configured to be worn on at least a portion of a digit of the hand and comprising:
at least one electrode connected to the flexible PCB and configured to be positioned in close contact with an area of the user's skin to provide electrical stimulation causing a referred sensation in another portion of the hand,
an electrode holder connected to the flexible PCB and configured to hold each of the at least one electrode close to the skin with an adjustable electrode setting, wherein each electrode holder is configured to enable adjustment of the at least one electrode to positions on a proximal-distal axis of the digit, and wherein the adjustable electrode setting comprises a track and anchoring mechanism for positioning the electrode at a radial position on the digit
selecting, by the controller, one or more electrodes of the at least one electrode to deliver the electrical stimulation to the user at a location of each of the selected one or more electrodes;
determining, by the controller, at least one parameter for the electrical stimulation to be delivered to each of the selected one or more electrodes based on the data related to the sensation; and
sending, by the controller, the electrical stimulation with the at least one parameter to each of the selected one or more electrodes to apply the electrical stimulation to cause the user to feel the referred sensation in the other portion of the hand.

16. The method of claim 15, wherein the external device is a remote device, an AR device, a VR device, or an XR device.

17. The method of claim 16, wherein the data related to the sensation to be felt by a user of the wearable device is related to a virtual touch experience of the user controlled by the remote device, the AR device, the VR device, or the XR device.

18. The method of claim 15, wherein the other portion of the hand comprises one or more locations remote from the selected one or more electrodes, wherein the one or more locations remote from the selected one or more electrodes comprises one or more fingertips of the user, allowing the user to experience a multi-reality interactivity providing virtual interaction with virtual objects and direct interaction with real world objects.

19. The method of claim 15, further comprising fitting the wearable device to the user's hand by:
attaching the hand portion of the wearable device to the hand of the user;
sizing the hand portion of the wearable device to fit the hand of the user;
positioning each of the at least one digit portion of the wearable device on the portion of the given digit of the hand; and
determining the position for the at least one electrode on the portion of the given digit for optimal referred sensation at a radial position.

20. The method of claim 19, wherein the determining the position for the at least one electrode further comprises:
sending, by the controller, one or more test electrical stimulations to each of the at least one electrode; and
positioning the at least one electrode at another radial position based on the referred sensation felt by the user after application of the one or more test electrical stimulations.
